(19) United States
(12) Patent Application Publication
(10) Pub. No.: US 2026/0027890 A1
(43) Pub. Date: Jan. 29, 2026

(54) VEHICLE FRONT STRUCTURE

(71) Applicant: TOYOTA JIDOSHA KABUSHIKI KAISHA, Toyota-shi Aichi-ken (JP)

(72) Inventor: Akifumi FUJIMOTO, Nisshin-shi Aichi-ken (JP)

(73) Assignee: TOYOTA JIDOSHA KABUSHIKI KAISHA, Toyota-shi Aichi-ken (JP)

(21) Appl. No.: 19/268,088

(22) Filed: Jul. 14, 2025

(30) Foreign Application Priority Data
Jul. 26, 2024 (JP) 2024-120970

(51) Int. Cl. B60K 11/06

(52) U.S. Cl. CPC B60K 11/06

(57) ABSTRACT

The vehicle front structure includes a duct provided on a front and side of the vehicle. The duct has an opening on the front side of the vehicle, and guides air flowing into the opening to the rear of the vehicle. A vehicle interior structure arranged adjacent to the inner side of the duct in the vehicle width direction. The duct includes a through-hole adjacent to the vehicle interior structure. A duct cover is provided to covers the through-hole from the inner side of the duct.

### CROSS REFERENCE TO RELATED APPLICATION

This application claims priority to Japanese Patent Application No. 2024-120970 filed on Jul. 26, 2024 including the specification, claims, drawings, and abstract is incorporated herein by reference in its entirety.

### TECHNICAL FIELD

This disclosure relates to a vehicle front structure having a duct that guides air taken in from the front of the vehicle to the rear.

### BACKGROUND

Conventionally, a duct is provided on the side of the front of a vehicle to guide the air taken in from the front of the vehicle to the rear. Such a duct has the role of directing the airflow to the rear and cooling devices that are heat sources such as batteries and radiators located at the rear portion where the air is directed.

Patent Document 1 discloses a duct that guides the air to a sub-battery mounted on a vehicle.

### PATENT DOCUMENTS

Patent Document 1: JP2008-213668A

### SUMMARY

In gasoline-powered vehicles, for example, the front compartment at the front of the vehicle is called the engine compartment, and its main purpose is to accommodate the engine and related components for driving. With the electrification of vehicles, the front compartment is now becoming place of accommodating many parts, such as motors and their control devices. For this reason, various vehicle interior structures are sometimes arranged adjacent to the ducts in the front compartment. In such cases, during a vehicle collision, the vehicle interior structures may come into contact with and be damaged by the ducts.

The front structure of the vehicle disclosed herein is provided on the side of the vehicle in the width direction at the front of the vehicle. The front structure includes a duct that has a opening at the front of the vehicle and guides air flowing into the opening to the rear of the vehicle, and a vehicle interior structure that is arranged adjacent to the inner side of the duct in the vehicle width direction. The duct includes a through-hole at the portion adjacent to the vehicle interior structure and a duct cover that covers the through-hole from the inner side of the duct.

The duct is divided into a front duct and a rear duct, and the through-hole may be provided in the front duct.

The duct cover may be attached to the periphery of the through-hole of the duct in a removable manner.

The duct may have a rear opening, and the air emitted from the rear opening may be directed to the cooling object mounted in the vehicle.

According to the vehicle front structure of this disclosure, the duct cover is retractable, and it is possible to suppress damage of the vehicle interior structure caused by contact with the duct which is deformed by during a collision.

### BRIEF DESCRIPTION OF DRAWINGS

FIG. 1: A schematic diagram showing the main components of the front structure of a vehicle, including the right front part of the front compartment.

FIG. 2: A diagram showing a corner pendulum test of a front structure of a vehicle that uses a duct of a comparative example.

FIG. 3: A schematic diagram showing a corner pendulum test of a front structure of a vehicle of an embodiment.

FIG. 4: A diagram showing a disassembled structure of a part of the duct.

### DESCRIPTION OF EMBODIMENT

The following describes the embodiments of this disclosure, with reference to the drawings. The following embodiments do not limit this disclosure, and the disclosure also includes configurations that are selective combinations of multiple examples.

### “Outline of the Main Components”

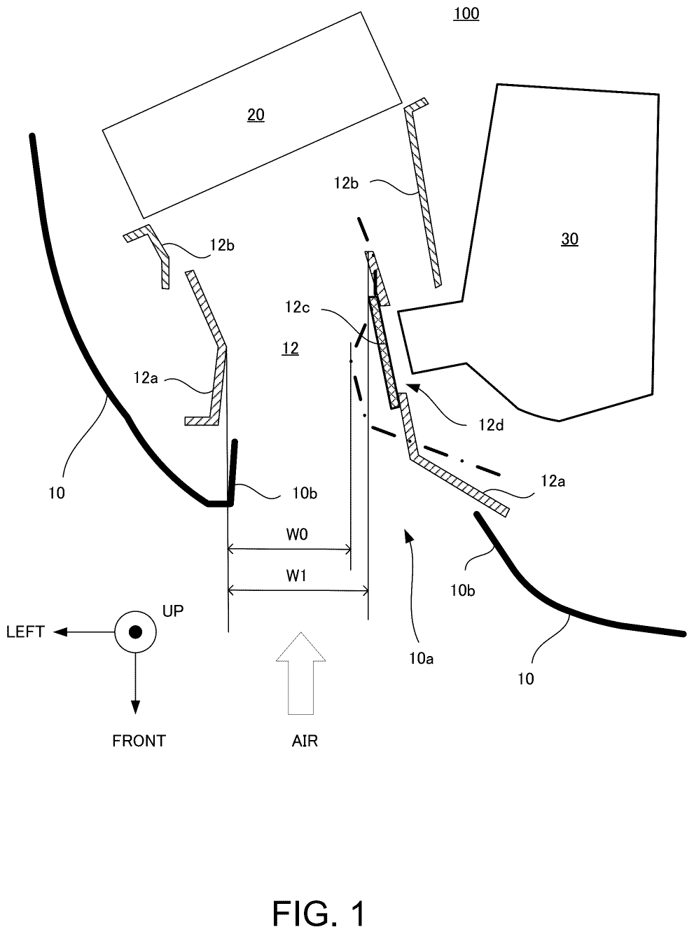

FIG. 1 is a schematic diagram showing the outline of the main components of the front structure 100 of a vehicle, including the right front part of the front compartment.

A bumper 10 is arranged to extend in the width direction of the vehicle at a predetermined width in the vertical direction at the lower part of the front end of the vehicle, and is attached to body members such as the body and chassis. In the figure, the outer shape of the bumper 10 is shown by a thick solid line.

An opening 10a is provided in the front side of the bumper 10 as a front opening of the duct 12. The opening 10a is formed as a hole inside the bumper 10, and the bumper 10 is located around the opening 10a. The peripheral part of the opening 10a of the bumper 10 is bent backward to form an introduction part 10b to the duct 12. In general, the opening 10a is provided at each of both sides of the bumper 10.

The front duct 12a is arranged opposite the introduction part 10b in the vehicle longitudinal direction. The inlet of the front duct 12a is larger than the introduction part 10b, and air from the introduction part 10b is taken in as it is. The front duct 12a is composed of a wall that surrounds the internal space as a conduit that extends in the longitudinal direction following the introduction part 10b. The front duct 12a is attached to the vehicle side member separately from the bumper 10.

The rear duct 12b is arranged behind the front duct 12a, and forms a duct that extends rearward from the front duct 12a. This rear duct 12b is an independent member from the front duct 12a, and is attached to the vehicle side member separately from the front duct 12a.

In addition, the rear duct 12b has a larger diameter than the front duct 12a, and the rear end of the front duct 12a terminates within the inlet of the rear duct 12b.

Therefore, the air flowing within the front duct 12a flows in the same direction within the rear duct 12b, and it is difficult for the air to flow out through the gap between the two. However, if the gap between the two is wide, air would leak from there, so a deformable caulking sponge or similar stuffs may be inserted into the gap.

The rear end of the rear duct 12b opens toward the cooling object 20 as a rear opening. The cooling object 20 may be a radiator for cooling motor cooling water, etc., but it may also be another component. The cooling object 20 is attached to the vehicle side member separately from the duct 12.

With this configuration, the running wind taken in through the opening 10a in the bumper 10 is directed towards the cooling object 20, and the cooling object 20 can be cooled.

Here, the vehicle interior structure 30 is arranged adjacent to the front duct 12a of the duct 12 in the vehicle width direction. This vehicle interior structure 30 is also separately attached to the vehicle side member. The vehicle interior structure 30 can be any type of structure, for example, a washer tank that stores the washer fluid for the window.

A through-hole 12d covered by a duct cover 12c is provided at the position closest to the vehicle interior structure 30 of the front duct 12a, i.e., at the adjacent portion of the front duct 12a to the vehicle interior structure 30, and at a location where the front duct 12a is likely to collide with the vehicle interior structure 30 if the front duct 12a moves during a collision of the vehicle. In this example, the duct cover 12c is provided to cover the through-hole 12d from the inner side of the duct 12. The duct cover 12 may be attached to the periphery of the through-hole of the duct in a removable manner.

In the example shown in the FIG. 1, the structure 30 inside the vehicle has a protrusion toward the duct 12. This protrusion is a seat for a wire harness provided on the side wall of the washer tank. The washer tank is cylindrical and has a length equivalent to that of the duct 12 in the vertical direction, but a portion for the seat for the wire harness is of approximately the same size in the horizontal and vertical directions and can pass through the through-hole 12d provided in the duct 12.

In this example, the peripheral edge of the duct cover 12c is fixed to the peripheral edge of the through-hole 12d. This fixing is not very strong, and is designed so that if the vehicle interior structure 30 collides with the duct cover 12c, the fixing is released and the duct cover 12c is removed from the duct 12. In other words, the duct cover 12c is designed to be able to move out of the way of the vehicle interior structure 30 so that the interior structure 30 is not destroyed when vehicle interior structure 30 collides with the duct cover 12c. As a fixing method, it is possible to use techniques such as adhesives, welding, screw fastening, and hooking the other side with a hook.

As will be described later, the duct cover 12c may be made to open and close like a door. For example, one side of the duct cover 12c may be attached to the duct 12 using hinges, and a hook for engagement may be provided on the other side of the duct cover 12c, which may be engaged with a protrusion or recess on the duct 12 to fix it in place. In this way, if the vehicle interior structure 30 collides to the duct cover 12c due to the vehicle collision, the hook will deform and the engagement will be released, allowing the duct cover 12c to open like a door.

In addition, the duct 12 is divided into a front duct 12a and a rear duct 12b, and the two correspond to each other at a predetermined distance. Therefore, even if the front duct 12a moves, there is no effect on the rear duct 12b until it collides with the rear duct 12b.

### “Corner Pendulum Test”

One of the bumper evaluation tests in the North American light collision regulations (49 CFR PART 581-BUMPER STANDARD) is the corner pendulum test. In this corner pendulum test, the bumper is impacted at the corner of the pendulum bumper, and the conditions for passing the test are that “no damage is caused to the body or functional parts, and that no parts other than the bumper cover assembly become detached or damaged” as a result of the impact.

In this case, a duct for guiding air, which is fixed to the body, may be set up facing the opening in the front bumper in order to direct air to the cooling object placed in front of the tires and fixed to the body. In this case, during the corner pendulum test, the pendulum may intrude and push the bumper, which in turn pushes the duct for guiding air, causing deformation. If there is a vehicle interior structure 30 fastened to the rear side of the duct, there is a possibility of strong interference between the duct and the vehicle interior structure 30, causing the fastening points of the vehicle interior structure 30, which is a part other than the bumper cover assembly, to come loose or be damaged.

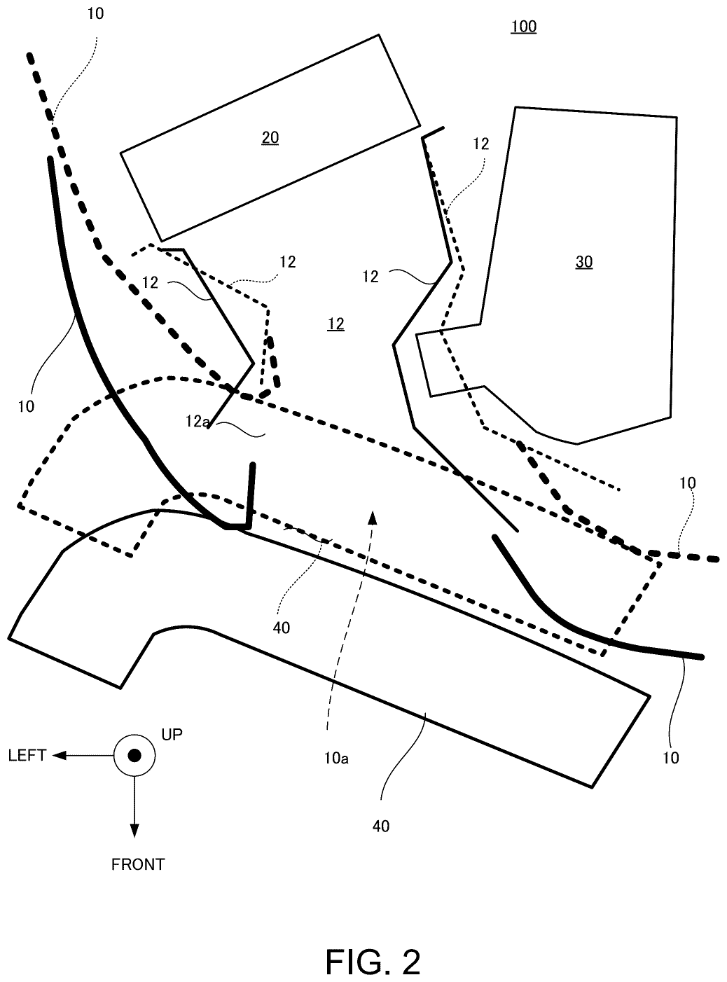

FIG. 2 shows a corner pendulum test of a vehicle front structure 100 that uses the duct 12 of the comparative example. In this figure, the pre-collision state is shown as a solid line and the post-collision state is shown as a dotted line. In this comparative example, the duct 12 has a single tubular configuration and guides the flow of air from the opening 10a in the bumper towards the cooling object 20 on the rear side. Note that the post-collision state shown as a dotted line in FIG. 2 is a schematic representation of the movement caused by the collision, and in reality there are various deformations in each component depending on the collision situation.

In this way, when the pendulum 40 moves to the rear of the vehicle, the bumper 10 dips backwards and collides with the duct 12. This causes the duct 12 to deform and collide with the vehicle interior structure 30 of the vehicle. There is a possibility that the fastening point between the duct 12 and the body member will come loose, or that the vehicle interior structure 30, which is a functional part, will be damaged.

### “State During Collision in the Embodiment”

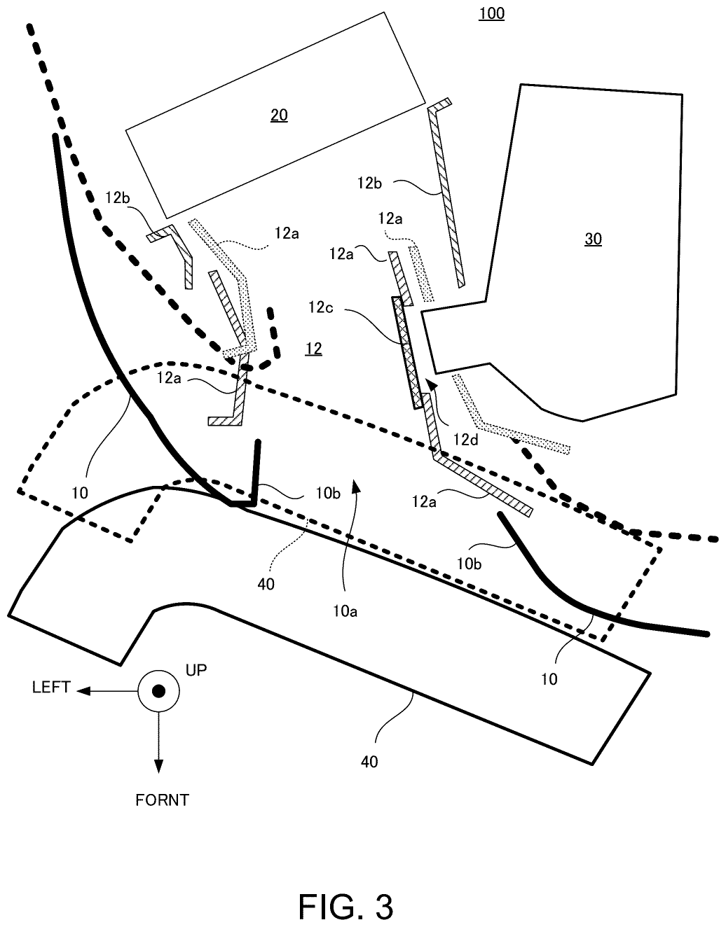

FIG. 3 is a schematic diagram showing the situation of the corner pendulum test in the vehicle front structure 100 of the embodiment.

As shown, the bumper 10 moves rearwardly in conjunction with the collision of the pendulum 40, and the front duct 12a moves rearwardly. The front duct 12a hits the protruding part of the vehicle interior structure 30, but the part of the front duct 12a that collides with the protruding part of the vehicle interior structure 30 has a through-hole 12d covered by the duct cover 12c. Therefore, the duct cover 12c of the front duct 12a hits the protruding part of the vehicle interior structure 30 and the duct cover 12c comes off the front duct 12a. As a result, the protruding part of the vehicle interior structure 30 will protrude from the through-hole 12d into the inside of the duct 12. However, the detachment of the fastening points of the vehicle interior structure 30 with the body will be avoided.

### “Structure of the Duct”

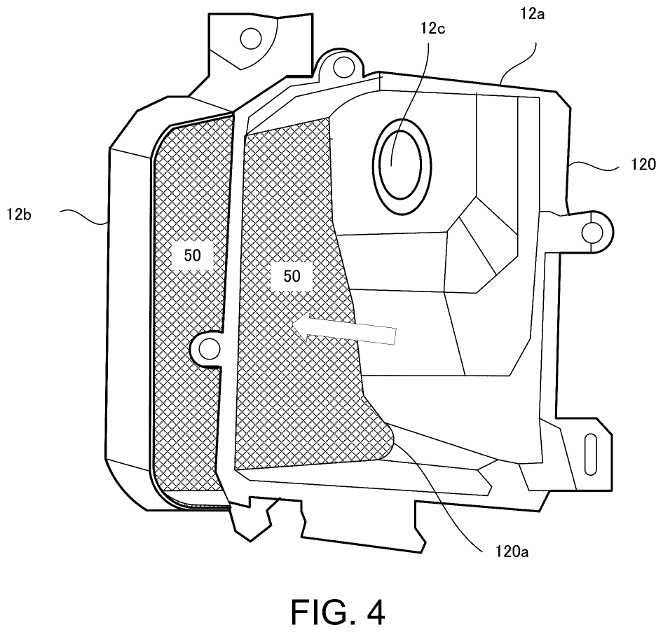

FIG. 4 is a disassembled structural diagram showing a section cut out of the duct 12. In this diagram, the front duct 12a, the inner wall 120 of the vehicle, and the hole 50 in the longitudinal direction are shown. The inner wall 120 is the wall on the side of the vehicle interior structure 30, and the part of the inner wall 120 corresponding to the vehicle interior structure 30 at the top of the inner wall 120 is raised toward the inside of the duct, and a hole is provided there, which is covered from the inside of the duct by the duct cover 12c. The rear side of the front duct 12a is a hole 50, through which air from the front is guided. In the figure, this hole 50 is indicated by a mesh.

In this example, the duct 12 is fixed to the bumper 10 by bolts or the like, but the front duct 12a is fixed separately from the rear duct 12b. By adopting this structure, damage to the body and functional parts in the event of a collision can be prevented, and at the same time, the clearance between the duct 12 and the rear objects such as the vehicle interior structure 30 can be reduced. Therefore, it is possible to make the opening of the entrance of the duct 12 larger, and it can also contribute to an increase in the amount of cooling air.

FIG. 2 shows a partial shape of the duct 12 that is not separated in the front and back in the comparative example. As shown in the figure, in the comparative example, the duct 12 bulges inward as shown by the dotted line to avoid interference with the vehicle interior structure 30 in the event of a collision. Therefore, in the comparative example, the inner diameter of the duct 12 at the inlet is W0. On the other hand, in the present embodiment, the duct cover 12c can be installed close to the vehicle interior structure 30, so the inner diameter of the duct 12 can be W1 that is larger than W0.

In this example, the lower part of the inner wall 120 has a cutout 120a that is recessed inward in the vehicle width direction. By providing such a cutout, interference of the duct 12 with other parts during a collision can be prevented.

1. A vehicle front structure comprising:
a duct provided on a side of a vehicle in a vehicle width direction and at a front part of the vehicle, having a front opening at a front side of the vehicle, and guiding air flowing in from the front opening to a rear of the vehicle; and
a vehicle interior structure arranged adjacent to an inner side of the duct in the vehicle width direction;
wherein the duct has a through-hole at a part adjacent to the vehicle interior structure and a duct cover which covers the through-hole from an inner surface side of the duct.

2. The vehicle front structure according to claim 1, wherein
the duct is divided into a front duct and a rear duct, and the through-hole is formed in the front duct.

3. The vehicle front structure according to claim 1, wherein
the duct cover is detachably attached to a periphery of the through-hole of the duct.

4. The vehicle front structure according to claim 2, wherein
the duct cover is detachably attached to a periphery of the through-hole of the duct.

5. The vehicle front structure according to claim 1, wherein
the duct has a rear opening, and the air discharged from the rear opening is directed to a target to be cooled mounted on the vehicle.

6. The vehicle front structure according to claim 2, wherein
the duct has a rear opening, and the air discharged from the rear opening is directed to a target to be cooled mounted on the vehicle.
